(19) United States
(12) Patent Application Publication
(10) Pub. No.: US 2022/0414610 A1
(43) Pub. Date: Dec. 29, 2022

(54) USER INTERFACE TO DYNAMICALLY UPDATE THE DISPLAY OF CHANGING WORK STEPS AND/OR WORK PLANS FOR WORK ORDERS

(71) Applicant: salesforce.com, inc., San Francisco, CA (US)

(72) Inventors: Dai Duong Doan, Alameda, CA (US); Rupa Singh, Fremont, CA (US); Shanis Kurundrayil, Fremont, CA (US); Keye Liu, Hercules, CA (US)

(73) Assignee: salesforce.com, inc., San Francisco, CA (US)

(21) Appl. No.: 17/360,070

(22) Filed: Jun. 28, 2021

(51) Int. Cl. G06Q 10/00; G06Q 10/06; G06Q 30/00; G06F 16/23; G06F 16/245; G06F 16/248

(52) U.S. Cl. CPC G06Q 10/20; G06Q 10/06315; G06Q 30/016; G06F 16/2379; G06F 16/245; G06F 16/248

(57) ABSTRACT

A user interface to dynamically update the display of work steps and/or work plans for work orders are described. A database system receives a request from a user interface to output a work order, and then identifies a work plan for the work order. The database system causes a user interface to output display fields for the work order and the work plan. The database system receives a request from a user of the database system to add an additional work plan and/or an additional work step, and then causes the user interface to dynamically update the output of the display fields for the work order and the work plan by adding an additional output of the at least one display field for the additional work plan and/or the additional work step.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

A work order can be a physical or electronic document that specifies what physical and/or mental activity is to be completed to accomplish a goal. A work order can also provide additional details, such as any materials used to accomplish the goal and the materials' prices. Sometimes referred to as a service ticket, job order, or work ticket, a work order may be sent from an outside customer to an organization or used internally by an organization to request work from a specific department.

A user such as a field service technician can enter work order information into a user interface that displays various work orders. For example, maintenance work orders display sections for a user to enter work details, labor and material costs, location, and a start date. A service work order enables a user to input the service provided, any parts required, any additional charges, and the service date.

For repairs to a building, a user can describe the repairs needed, assign due dates for completing the repairs, and then document any expenses. A user can fill out information about a car at the top of an automotive work order for maintenance or repair work, and then add details about labor and parts in the spaces below. A user can also record a requested Information Technology (IT) action, the date of the request, and details about the work in an IT services work order.

### BRIEF SUMMARY

In accordance with embodiments, there are provided systems and methods for a user interface to dynamically update the display of changing work steps and/or work plans for work orders. A database system receives a request from a user interface to output a work order, and then identifies a work plan for the work order. The database system causes the user interface to output display fields for the work order and the work plan. If an input is received from the user interface and is associated with at least one of the display fields for the work order, the work plan, and any work steps, the database system can dynamically update database records associated with the at least one display field for the work order, the work plan, and any work steps. The database system receives a request from a user of the database system to add an additional work plan and/or an additional work step, and then causes the user interface to dynamically update the output of the display fields for the work order and the work plan by adding an additional output of at least one display field for the additional work plan and/or the additional work step.

For example, Excellent Home Service company's work order system receives a request from their work order application on their field service technician John's mobile phone to display a work order for repairing a customer Jenny's automatic garage door opener. The work order system identifies work plans and work steps for the work order for repairing the garage door opener. Then the work order system sends the display fields for the work order, work plans, and work steps, which are displayed on the mobile phone's work order application while John is in Jenny's garage.

While following a work step to evaluate the garage door opener's electrical service panel, John determined that the electrical service panel needs to be upgraded for the garage door opener to function properly, so he explains this need to Jenny and enters this information in his work order application, which is received by the work order system which dynamically updates the work order and notifies John's service manager. The service manager calls Jenny to confirm her agreement to upgrade her electrical service panel, and then adds a work plan and its work steps to upgrade an electrical service panel into the work order system. Then the work order system sends the display fields for the work order's additional work plans and steps to dynamically update the work order's displayed fields for work plans and steps on the mobile phone's work order application while John is in Jenny's garage. The dynamically updated work plans and work steps instantly provide John with everything he needs as he upgrades the electrical service panel and completes the work order for the garage door opener, which makes Jenny happy.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1A is an operational flow diagram illustrating a high-level overview of a method 100 for a user interface to dynamically update the display of changing work steps and/or work plans for work orders, in an embodiment;

FIGS. 2 A and B depict example frames of work orders for large and small user interfaces to dynamically update the display of changing work steps and/or work plans for work orders, in an embodiment;

FIG. 3 depicts an example frame for a back-end user interface for selecting and configuring display fields for a user interface to dynamically update the display of changing work steps and/or work plans for work orders, in an embodiment;

FIG. 4 depicts another example frame for a back-end user interface for selecting and configuring display fields for a user interface to dynamically update the display of changing work steps and/or work plans for work orders, in an embodiment;

FIG. 5 depicts an example frame for a back-end user interface for creating custom display fields for a user interface to dynamically update the display of changing work steps and/or work plans for work orders, in an embodiment;

FIGS. 6 A-H depict example paired frames for a back-end user interface for selecting and configuring display fields and for a user interface to dynamically update the display of changing work steps and/or work plans for work orders, in an embodiment;

FIG. 7A, FIG. 7B, and FIG. 7C depict an example frame 700 for work order steps, a subsection of an example data model 730, and an example frame 760 for work order steps for a user interface to dynamically update the display of changing work steps and/or work plans for work orders, in an embodiment;

FIG. 8 illustrates a block diagram of an example of an environment 800 wherein an on-demand database service might be used; and

FIG. 9 illustrates a block diagram of an embodiment 900 of elements of FIG. 8 and various possible interconnections between these elements.

### DETAILED DESCRIPTION

### General Overview

Systems and methods are provided for a user interface to dynamically update the display of changing work steps and/or work plans for work orders. As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, a method, frames, and systems for a user interface to dynamically update the display of changing work steps and/or work plans for work orders will be described with reference to example embodiments. The following detailed description will first describe an example method and frames for a user interface to dynamically update the display of changing work steps and/or work plans for work orders. Then systems for a user interface to dynamically update the display of changing work steps and/or work plans for work orders are described.

While one or more implementations and techniques are described with reference to an embodiment in which a user interface to dynamically update the display of changing work steps and/or work plans for work orders is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

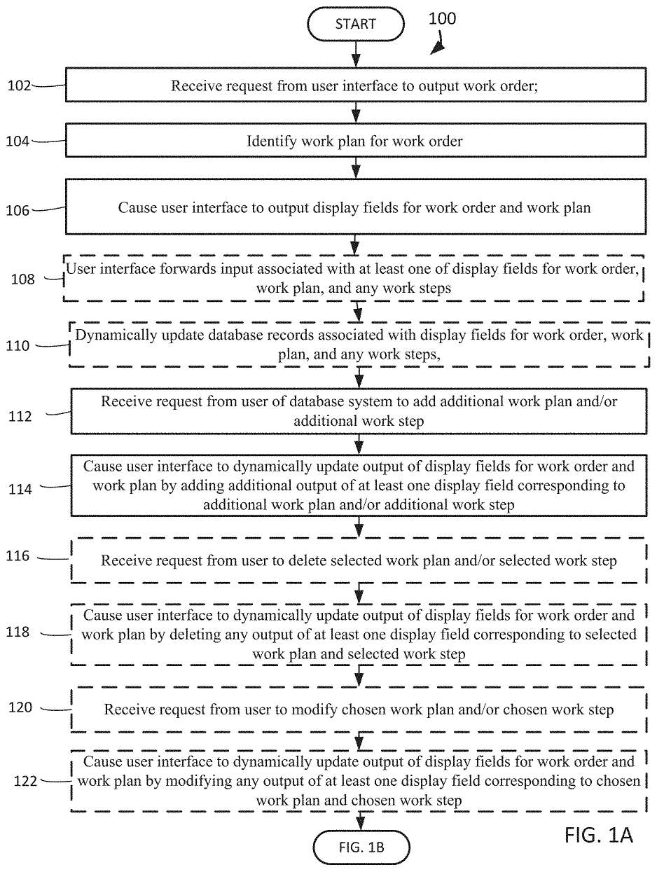

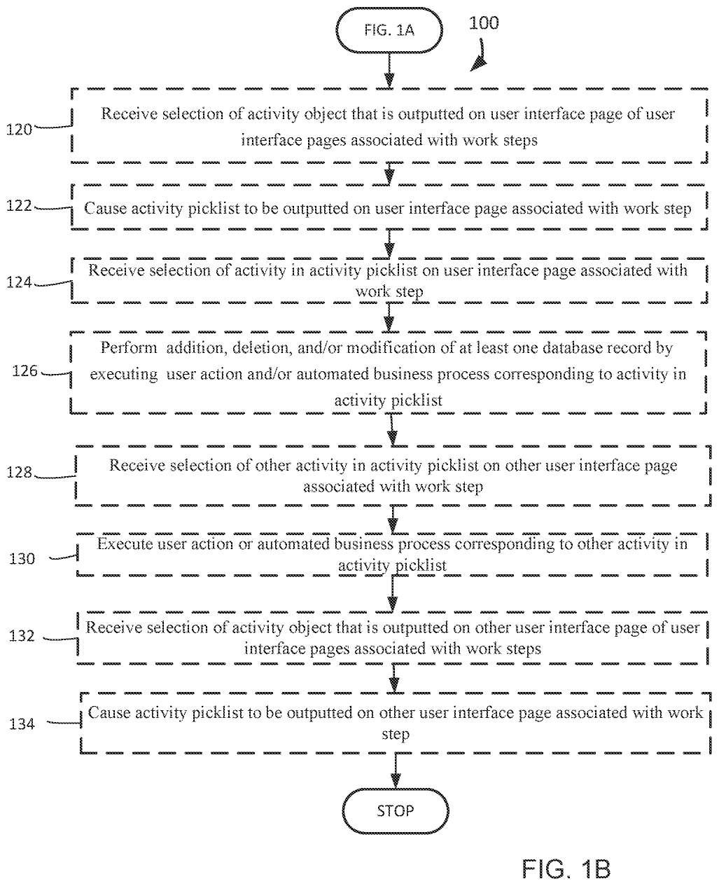

FIG. 1A and FIG. 1B are operational flow diagrams illustrating a high-level overview of a method 100 for a user interface to dynamically update the display of changing work steps and/or work plans for work orders. A request is received from a user interface to output a work order, block 102. A system receives a field service technician's request to display a work order. For example, and without limitation, this can include a database system, such as a work order system for Excellent Home Service company, receiving a request from their work order application on their field service technician John's mobile phone to display a work order for repairing a customer Jenny's automatic garage door opener.

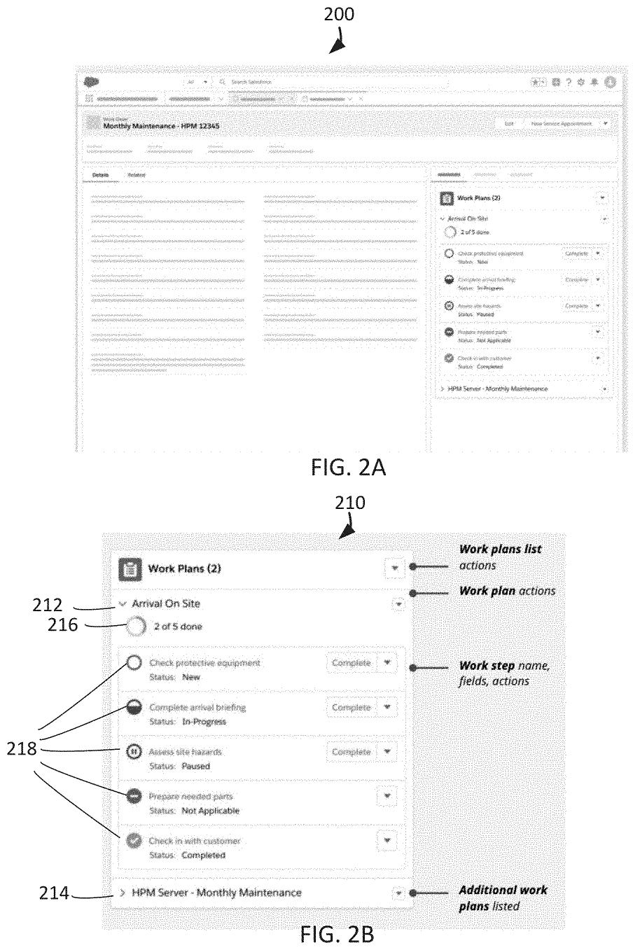

A request can be an instruction to a computer to provide information or perform another function. A user interface can be any element of interaction between a computer system and a human; and can include any number of modalities of interaction (such as graphics, sound, position, and movement) where data is transferred between the human and the computer system. FIG. 2A depicts an example frame 200 of a work order for a large user interface which may be used to select and configure display fields for a user interface which dynamically updates the display of changing work steps and/or work plans for work orders, in an embodiment.

After receiving a request to output a work order, a work plan is identified for the work order, block 104. The system identifies a work order's work plans. By way of example and without limitation, this can include the work order system identifying work plans and work steps for the work order for repairing the garage door opener. Any type of work plan can be a document or file which outlines a set of goals and processes by which a team or a person can accomplish those goals.

Following the identification of a work plan for a work order, the user interface is caused to output display fields for the work order and the work plan, block 106. The system displays the requested work order and its work plans. In embodiments, this can include the work order system sending the display fields for the work order, the work plans, and any work steps that are displayed on the mobile phone's work order application while John is in Jenny's garage. A display field can be an item of data shown on a computer screen.

FIG. 2B depicts an example frame 210 of a work order for a small user interface which can dynamically update the display of changing work steps and/or work plans for work orders, in an embodiment. Since a field service technician may be using a mobile device that has a relatively small user interface, a user of the database system may configure which display fields of a work order's work plans and steps are displayed on the relatively small user interface and which of these display fields are not displayed on the relatively small user interface. For example, the frame 210 depicts that the user interface is configured as an initial default to expand and display the work order's first work plan 212 and collapse the display of any subsequent work plans 214 for the work order.

The field service technician's user interface structures work plans list actions driven by work plan list view actions, which are configured in a setup via a search layout →list view. Similarly, work plan actions are driven by a work order→work plan related list actions. Likewise, work step actions and fields are driven by a work plan→work step related list.

A field service technician can execute each work step, review and document the work after it is completed, and then automatically update each work step's status by just a single click. A field service technician can use the user interface's progress rings 216 and check lists 218 to complete all work steps, which ensure that no work steps are missed. The back-end office can connect to the field service technician's user interface and review the field service technician's work progress in real time.

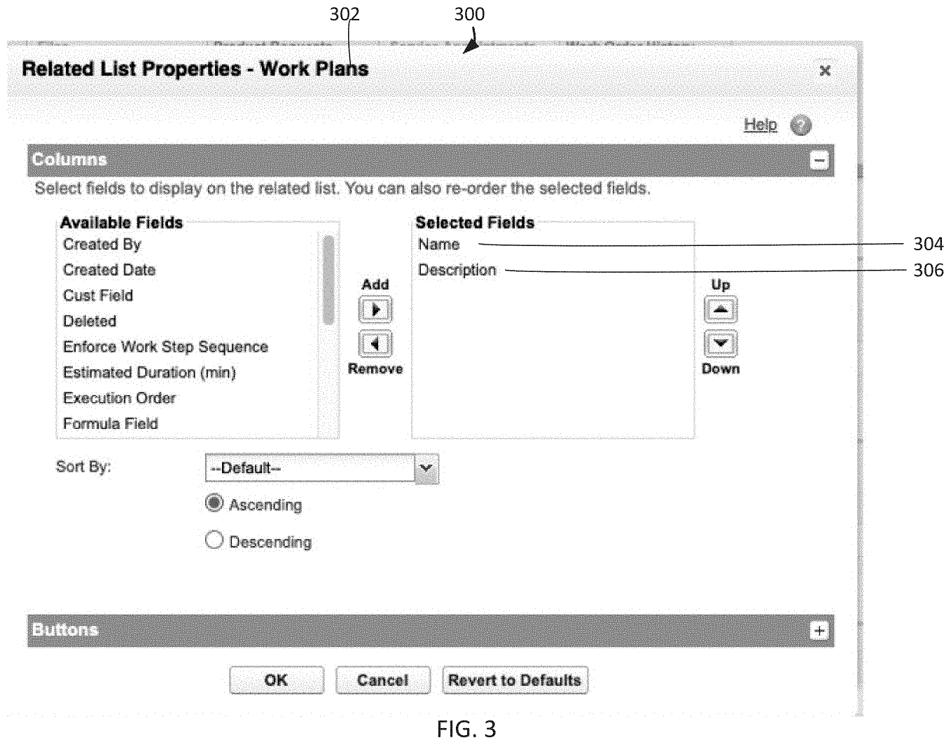

Examples of further configurations of which display fields will be output and dynamically updated via user interfaces are depicted in FIGS. 3 to 6H and described below in reference to FIGS. 3 to 6H. Although these examples will describe display fields which are configured to be output to and dynamically updated on a user interface that has a relatively small size, these same display fields may be configured to be output to and dynamically updated on a user interface that has any relative size.

Having output display fields for a work order and a work plan, an input is optionally received from a user interface and is associated with at least one of the display fields for the work order, the work plan, and any work steps, block 108. The system can receive a user's input about a displayed field for a work order, plan, or step. For example, and without limitation, this can include a work order system receiving John's entry of information in his work order application which indicates that during a work step to evaluate the garage door opener's electrical service panel, Jenny explained that the circuit breakers for the garage door opener and other appliances had been frequently tripping.

John concludes that an upgrade to a 200-amp electrical service panel should resolve Jenny's problems of frequently tripping circuit breakers because Jenny's 100-amp electrical service panel no longer provides enough electrical capacity for her home, which includes several 240-volt appliances and central air-conditioning. Therefore, John recommends that the 100-amp electrical service panel needs to be upgraded to a 200-amp electrical service panel for the garage door opener to function properly, and John explains his recommendation to Jenny for her to upgrade her electrical service panel. An input can be information that enters a system. Any type of work step can be an outline of a task for a team or a person to accomplish a goal.

After the user interface forwards an input associated with at least one of the display fields for the work order, the work plan, and any work steps, database records associated with display fields for work order, work plan, and any work steps, are optionally dynamically updated, block 110. The system can respond to a user's input by dynamically updating database records. By way of example and without limitation, this can include the work order system dynamically updating the work order system's database records about the need to upgrade Jenny's 100-amp electrical service panel to a 200-amp electrical service panel, and then notifying John's service manager about Jenny agreeing with John to make this upgrade. A database record can be a structured set of related items of information that are handled as a unit by a computer. Dynamically updating can be the real-time or near real-time refreshing of information to incorporate the most recent changes.

Table 1 below identifies two different objects with two different variations in their layouts, field filtering, and custom field creation.

TABLE 1

| | Parent | Work Plan | Work Step |
|---|---|---|---|
| No. | Objects | Layouts (fields) | Layouts (fields) |
| 1 | Work Order | Name, Description | Description, Status |
| 2 | Work Order | Name, Estimated | Status, Execution Order |
| | | Duration | |
| 3 | Work Order | Name, Estimated | Status, Execution Order |
| | Line Item | Duration | |
| 4 | Work Order | Name, Description | Description, Status |
| | Line Item | | |

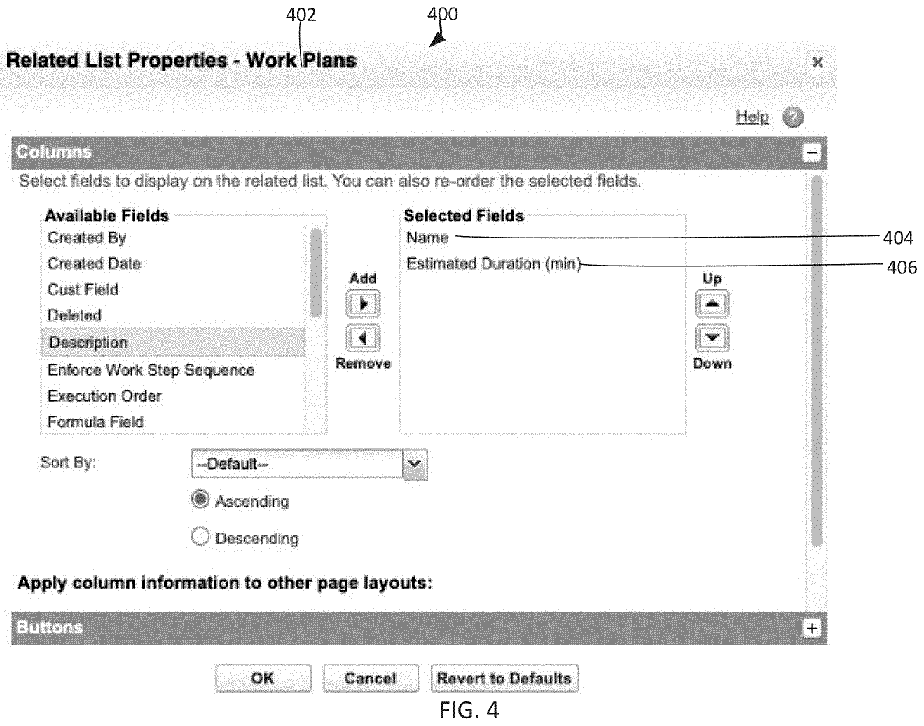

FIG. 3 and FIG. 4 depict the corresponding frames 300 and 400 of back-end user interfaces for selecting and configuring which display fields for work orders, work plans, and work steps are displayed and dynamically updated by the user interfaces of field service technicians. Each display field which is output to a user interface of a field service technician may be initially selected via a back-end user interface by a specified database system user, such as a system administrator a service manager, or dispatcher, from all potentially configurable display fields for work orders, work plans, and work steps. After such a display field is selected in the back-end user interface, such a database user can individually configure each selected display field to be output and to be dynamically updated in user interfaces of field service technicians.

For example, the frame 300 depicts that a specified database system user selected the “work plan” object 302, and then configured only the “description” display field 304 and the “name” display field 306, from more than eight of the work order's display fields, to be output and to be dynamically updated on user interfaces of field service technicians. This selection and configurations reflect row 1 in the above table 1, which lists objects with variations in their layouts and their display field filtering. For another example, the frame 400 depicts that a specified database system user selected the same “work plan” object 402, and then configured only the different “estimated duration” display field 404 and the same “name” display field 406, from more than eight of the work order's display fields, to be output and to be dynamically updated on user interfaces of field service technicians, This selection and configurations, which may have been made by the same or a different database system user at a different time from the FIG. 3 selection and configurations, reflects row 2 in the above table 1, which lists objects with variations in their layouts and their display field filtering. Consequently, the same user interfaces for the same field service technicians can display different display fields for the same object based on each set of selection and configurations. Rows 2 and 3 in the above table 1 indicate that the same user interface for the field service technician can display the same display fields for different objects based on each set of selection and configurations.

This flexibility in outputting display fields enables specified database system users to reuse the same user interfaces for the field service technicians to output different display fields from different objects through simple selection and configurations without requiring any reprogramming. At runtime, the user interfaces for the field service technicians will dynamically load the display fields based on the selected objects and their layouts to display only configured display fields. The display fields output in the user interfaces for the field service technicians are dynamically configured, and not hard-coded.

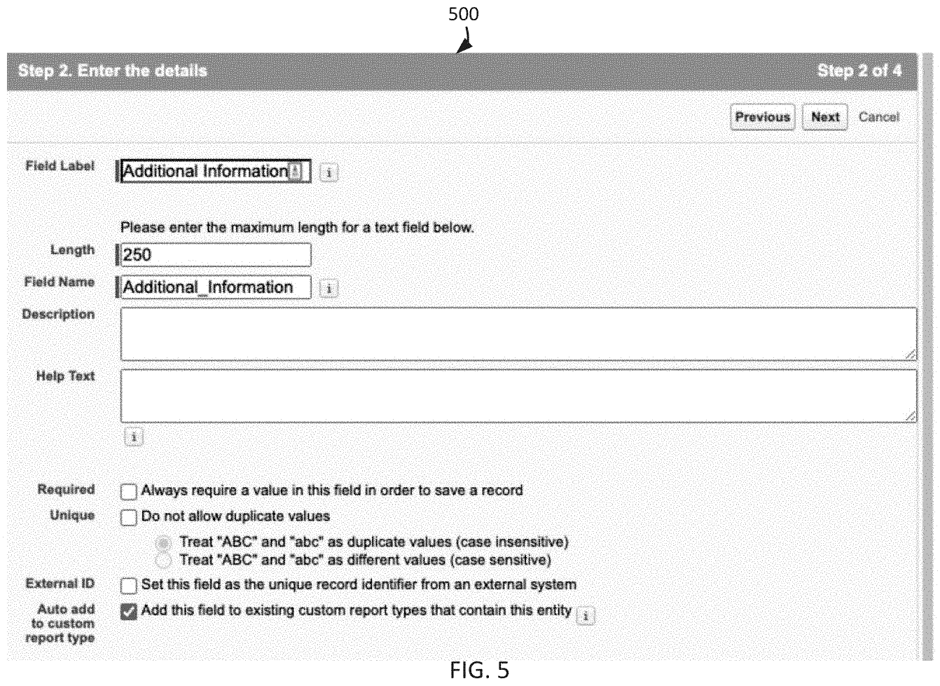

FIG. 5 depicts an example frame 500 for a back-end user interface for creating custom display fields for a user interface to dynamically update the display of changing work steps and/or work plans for work orders, in an embodiment. These user interfaces for the field service technicians also support custom display fields created by the specified database system users. For example, a service manager creates a custom display field for a custom work step that specifies the use of at least one 50-amp circuit breaker in a work plan for upgrading a 100-amp electrical service panel into a 200-amp electrical service panel. Traditional display fields in traditional user interfaces do not have this extensive flexibility. Traditional user interfaces display the same set of display fields for each type of object, and do not permit custom display fields to be added by any special database system user without requiring reprogramming.

Similarly, a specified database system user can dynamically configure standard actions for responding to custom work plans and steps, dynamically configure the displaying and the dynamically updating of such standard actions, dynamically configure custom actions for responding to any type of work plans and steps, and dynamically configure the displaying and the dynamically updating of such custom actions. For example, a service manager creates a custom display field for an action to respond to a custom work step that specifies the use of at least one 50-amp circuit breaker in a work plan for upgrading a 100-amp electrical service panel into a 200-amp electrical service panel. The action to respond to this custom work step could be a standard action, such as verifying that the custom work step has been done, or a custom action, such as ordering a 50-amp circuit breaker.

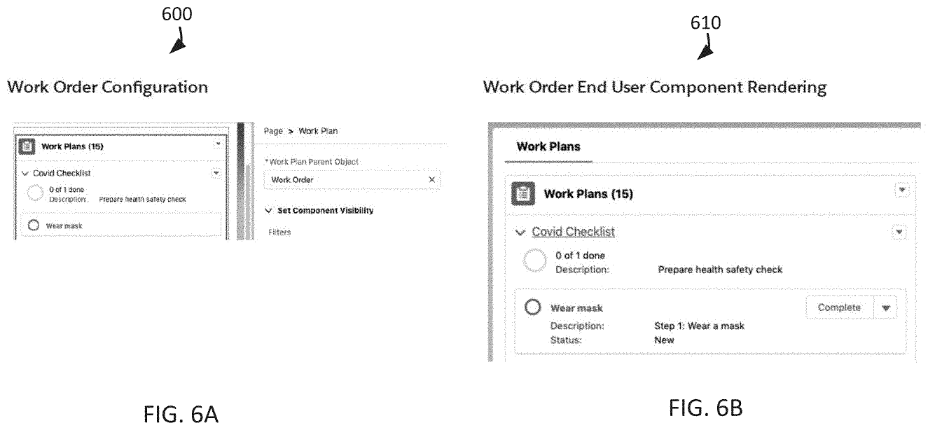

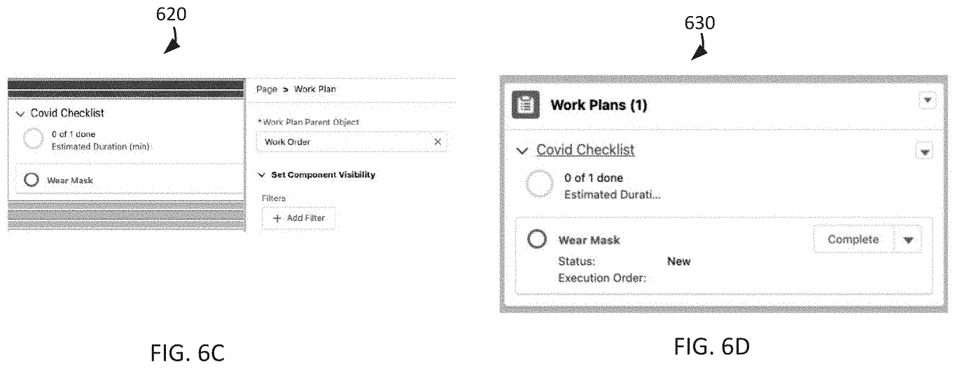

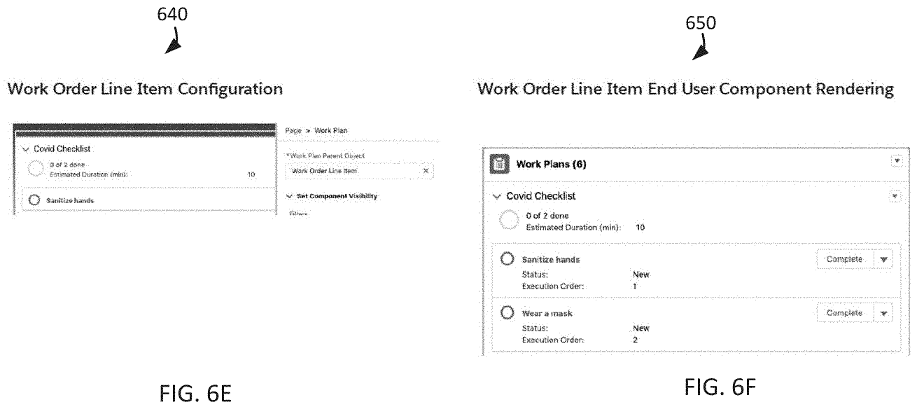

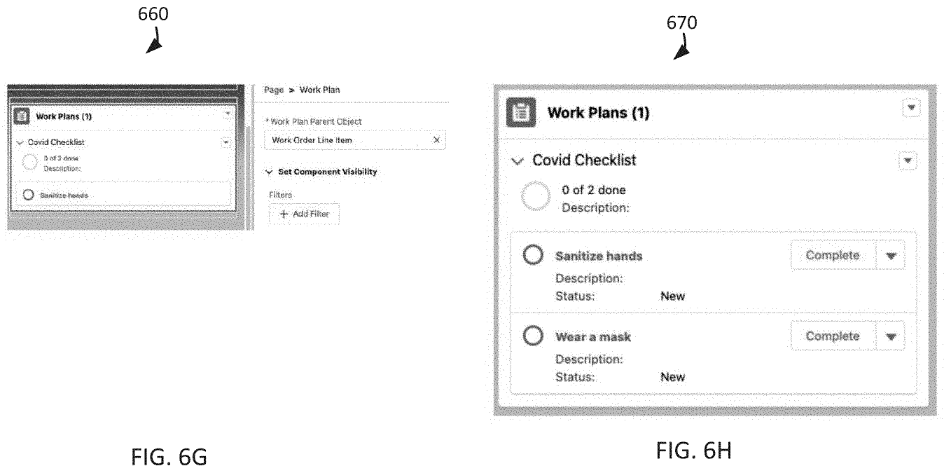

FIGS. 6 A-H depict example paired frames for a back-end user interface for selecting and configuring display fields and for a user interface to dynamically update the display of changing work steps and/or work plans for work orders, in an embodiment. FIG. 6A depicts the frame 600 for a back-end user interface which selects and configures the layout of display fields for work orders on a field service technician user interface, which is depicted by FIG. 6B as the frame 610 which lays out the “name” and “description” display fields for the work plan and the “description” and “status” display fields for the work step, as listed by row 1 of the above table 1. FIG. 6C depicts the frame 620 for a back-end user interface which selects and configures the layout of display fields for work orders on a field service technician user interface, which is depicted by FIG. 6D as the frame 630 which lays out the “name” and “estimated duration” display fields for the work plan and the “status” and “execution order” display fields for the work step, as listed by row 2 of the above table 1. FIG. 6E depicts the frame 640 for a back-end user interface which selects and configures the layout of display fields for work order line items on a field service technician user interface, which is depicted by FIG. 6F as the frame 650 which lays out the “name” and “estimated duration” display fields for the work plan and the “status” and “execution order” display fields for the work step, as listed by row 3 of the above table 1. FIG. 6G depicts the frame 660 for a back-end user interface which selects and configures the layout of display fields for work order line items on a field service technician user interface, which is depicted by FIG. 6H as the frame 670 which lays out the “name” and “description” display fields for the work plan and the “description” and “status” display fields for the work step, as listed by row 4 of the above table 1.

Following a user interface outputting the display fields for a work order and a work plan, a request is received from a user of a database system to add an additional work plan and/or an additional work step, block 112. The system receives user requests to add work plans and/or steps to the displayed work order and/or plan. In embodiments, this can include the work order system receiving a request from John's service manager to add a work plan and its work steps for upgrading a 100-amp electrical service panel to a 200-amp electrical service panel into the work order, after the service manager called Jenny to confirm her agreement to upgrade her 100-amp electrical service panel.

Service managers and dispatchers make last minute adjustments to work plans automatically attached work orders as the work needed evolves, or in response to customer requests, and also review field service technician's progress to stay current on what is happening in the field. A database system can be computer software and/or hardware that interacts with a user and software applications to capture and analyze the quantities, characters, and/or symbols on which operations are performed by a computer, being stored, and transmitted in the form of electrical signals and being recorded on magnetic, optical, and/or mechanical recording media. A user can be a person who operates a computer.

Once a database system receives a request from a user of a database system to add an additional work plan and/or an additional work step, a user interface is caused to dynamically update the output of the display fields for the work order and the work plan by adding an additional output of at least one display field for the additional work plan and/or the additional work step, block 114. The system dynamically updates the display of work orders and plans with additional work plans and/or steps. For example, and without limitation, this can include the work order system sending the display fields for the work order's additional work plans and steps to dynamically update the work order's displayed fields for work plans and steps on the mobile phone's work order application while John is in Jenny's garage.

The user may create the additional work plan as a custom work plan and/or create the additional work step as a custom work step. For example, when adding a work plan and its work steps for upgrading a 100-amp electrical service panel to a 200-amp electrical service panel to the work order to repair Jenny's garage door opener, the service manager adds a custom work step which specifies using a 50-amp circuit breaker to support an electrical vehicle charger for Jenny's pending purchase of an electrical car. The dynamically updated work plans and steps provide John with everything he needs to upgrade Jenny's 100-amp electrical service panel to a 200-amp electrical service panel and complete the work order for the garage door opener, which makes Jenny happy. Any type of output can be information produced by a computer.

When a user interface outputs the display fields for a work order and a work plan, a database system optionally receives a request from a user to delete a selected work plan and/or a selected work step, block 116. The system can receive a user's request to delete work plans and/or steps. By way of example and without limitation, this can include the work order system receiving the service manager's request to delete the work step for accommodating 220-volt circuit breakers from the work plan to upgrade Jenny's 100-amp electrical service panel, because John's photo of Jenny's electrical service panel and his interview of Jenny indicate that Jenny's electrical service panel does not have or need any 220-volt circuit breakers.

If a database system receives a request from a user to delete a selected work plan and/or a selected work step, a user interface is optionally caused to dynamically update the output of the display fields for a work order and a work plan by deleting any output of at least one display field corresponding to the selected work plan and/or the selected work step, block 118. The system can dynamically delete the displayed fields for work plans and/or steps that have been deleted. In embodiments, this can include the work order system dynamically deleting the display field for the work step for using 220-volt circuit breakers in the work plan to upgrade Jenny's 100-amp electrical service panel to a 200-amp electrical service panel from the mobile phone's work order application while John is in Jenny's garage.

After a user interface outputs the display fields for a work order and a work plan, a database system optionally receives a request from a user to modify a chosen work plan and/or a chosen work step, block 120. The system can receive a user's request to modify work plans and/or steps. For example, and without limitation, this can include the work order system receiving the service manager's request to modify a work step that specifies the use of only 24-amp circuit breakers into a modified work step that specifies the use of at least one 50-amp circuit breaker, in the work plan to upgrade Jenny's 100-amp electrical service panel to a 200-amp electrical service panel. During the service manager's phone interview of Jenny, the service manager determined that Jenny's 100-amp electrical service panel needs a 50-amp circuit breaker to support an electrical vehicle charger for Jenny's pending purchase of an electrical car.

If a database system receives a request from a user to modify a chosen work plan and/or a chosen work step, a user interface is optionally caused to dynamically update the output of display fields for the work order and the work plan by modifying any output of at least one display field corresponding to at least one of the chosen work plan and the chosen work step, block 122. The system can dynamically modify the displayed fields for work plans and/or steps that have been modified. By way of example and without limitation, this can include the work order system dynamically modifying the display field for the work step that specifies the use of only 24-amp circuit breakers into specifying the use of at least one 50-amp circuit breaker in the work plan to upgrade Jenny's 100-amp electrical service panel to a 200-amp electrical service panel in the mobile phone's work order application while John is in Jenny's garage. A service manager can add, delete, and modify work plans and/or work steps, which are dynamically updated in the user interfaces for the field service technicians in real time. The user interfaces for the field service technicians are dynamically updated to list all the work plans and steps associated with a work order.

The work order system has the flexibility to adapt to ad hoc requirements of users, such as by enabling a user to add a work plan, delete a work plan, or modify all work plans to include recent modifications to work steps, or to add a work step, delete a work step, or modify a work step. For example, if the field service technician Joe reviews records which indicate that he recently replaced the brakes on the customer Brian's Mercedes Benz, and Joe also notices that the car's headlights need to be replaced, Joe can delete the brake check work plan from the initially created work order and add a headlight replacement work plan that was not part of the initially created work order. Although this example describes a work order for a single asset, the work order may include work order line items that each correspond to a different asset. For example, an application may use a large organization's maintenance plan to access a work plan library and generate a single work order which schedules a large number of cars for an oil change within the same time period.

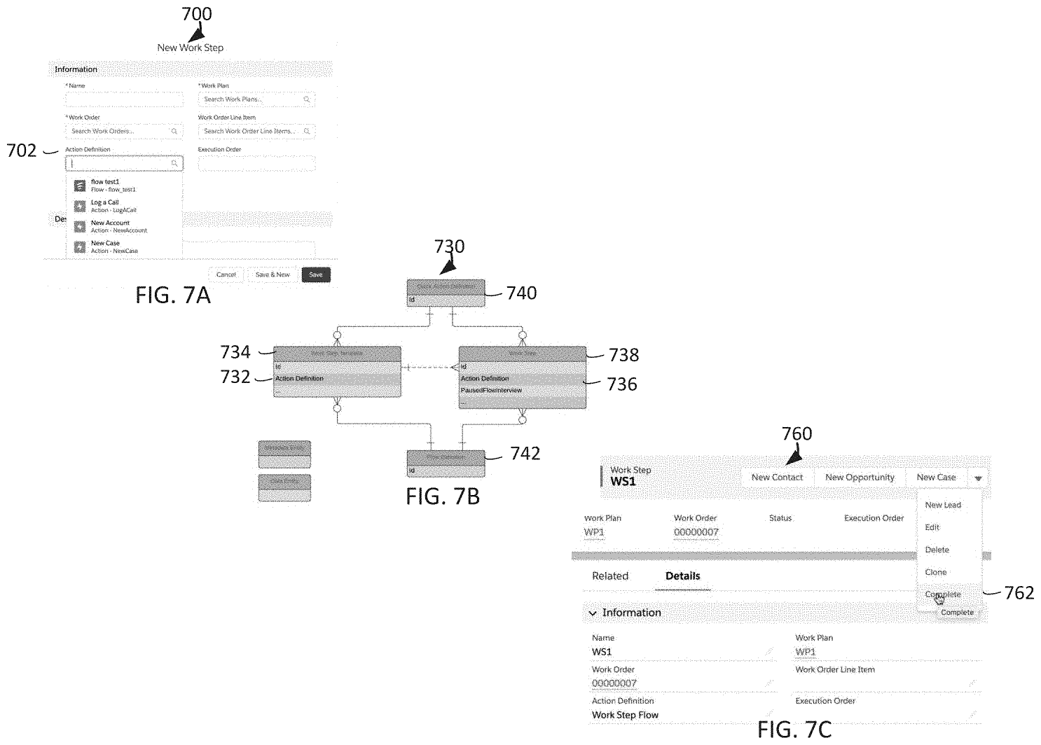

FIG. 7A depicts an example frame 700 of configurable work step, FIG. 7B depicts an example frame 730 of a subsection of an example data model, and FIG. 7C depicts an example frame 760 of an executable work step. A software vendor's system administrator and/or a customer's end user (such as a system administrator or a field service technician) can configure which actions and which flows may be executed from a user interface page for a work step. For example, the frame 700 depicts a system administrator configuring a new work step template to enable a field service technician working in the field to execute various actions 702, such as launching a flow test, logging a call, creating a new account, and creating a new case.

A software vendor can be a provider of programs and other operating information used by a computer. An end user can be a person that utilizes an item. Dynamically can be relating to configurations that update frequently.

An action, which may be referred to as an activity, may be defined as either a quick action definition, a global action definition, or a flow definition, and may be stored in in an action definition field 732 in a work step template 734 and/or an action definition field 736 in a work step object 738, as depicted in the frame 730. Each action definition may be vendor-defined, which is an “out of the box” action definition, or customer defined, which is a customized action definition. Both the quick action definition object 740 and the flow definition object 742 depicted in the frame 730 store metadata definition. The work step template 734 and/or the work step object 738 has a one-to-many relationship with the quick action definition object 740 and/or the flow definition object 742.

Any activity definition object 740 and/or 742 stores a reference for launching an activity. The work order system uses a standard action to launch a quick action, launch a global action, resume, or pause a flow, or directly update a record field or a status. Since one standard action can dynamically launch these four activity types, an end user may select a single activity object to perform multiple different types of activities.

Every system administrator and every end user, such as a field service technician working in the field, can perform one or multiple activities by changing the actions after performing one action after another action. Once an activity is completed, the activity definition object 740 and/or 742 may be repurposed for a different activity launch. A paused/flow/interview object stores a flow reference, which has been paused, for later invocation.

Frame 760 depicts the user interface for a field service technician working in the field, in which the field service technician is selecting from a pick list 762 from a work step table, to update a record field by indicating that the status of the displayed work step is complete. Subsequently, the system can analyze the completed work orders, and then generate dashboards and service reports that monitor and improve key performance indicators.

A work step may be associated with an execution order, an execution status, a start time, a stop time, and/or a duration. For example, the start time of the first work step for a high-performance process manager maintenance is scheduled for 3:00 A.M. Sunday, the stop time for the last work step for the high-performance process manager maintenance is scheduled for 4:00 A.M. Sunday, the maintenance duration is scheduled for an hour, and at 3:10 A.M. the status of the first work step is completed, the status of the second work step is executing, and the statuses of the remaining work steps are pending.

Following the output of a work order that includes work plans that have work steps, a selection is optionally received of an activity object that is outputted on a user interface page of user interface pages associated with the work steps, block 124. The system can output work step pages that include selectable objects. For example, and without limitation, this can include the work order system receiving Joe's selection of a “complete” button displayed on the work step page for checking the tire pressure.

While confirming that Brian's tire pressure is in the manufacturer's suggested pressure range, Joe notices that the tire tread is low on all four tires and recommends that Brian replace the tires soon, to which Brian agrees. A selection can be the action of carefully choosing something as being the most suitable. An activity object can be a selectable data construct that provides a description of something that may be used by a computer to achieve a goal. A user interface page can be a section of information displayed on a screen that a person operating a computer uses to interact with the computer.

Having received a selection of an activity object, an activity picklist is optionally caused to be outputted on a user interface page associated with a work step, block 126. The system can display activity picklists on work step pages. For example, and without limitation, this can include the work order system displaying a picklist on the check tire pressure work step page. An activity picklist can be a data construct that provides a description of somethings that may be selected to be used by a computer to achieve a goal.

After causing an activity picklist to be outputted on a user interface page associated with a work step, a selection is optionally received of an activity in the activity picklist, block 128. The system can receive selections of activities from activity picklists on work step pages. By way of example and without limitation, this can include the work order system receiving Joe's selection of a salesforce.com lightning flow for ordering new tires from the picklist. An activity can be something that may be used to achieve a goal.

Following the selection of an activity in an activity picklist that is output on a user interface page associated with a work step, an addition, a deletion, and/or a modification of at least one database record is optionally performed by executing a user action or an automated business process corresponding to the activity in the activity picklist, block 130. The system can enable a field service technician working in the field to flexibly capture data by launching actions or flows while viewing specific work step pages. In embodiments, this can include the work order system creating a database record for the prospective order of new tires by launching a salesforce.com lightning flow for ordering new tires from the check tire pressure work step page. When creating a database record, the work order system captures data in the field in real time, which enables a system administrator in the back office to monitor and audit the activities of a field service technician in real time when the field service technician is working in the field.

An addition can be the action of inserting an entity into a group of entities. A deletion can be the action of removing an entity from a group of entities. A modification can be the action of altering an entity to improve the entity.

Performing an addition, deletion, and/or modification of any database record can include updating a record of a status of a work step which corresponds to a user interface page on which the activity picklist is displayed. Executing a user action or an automated business process corresponding to an activity in an activity picklist can include linking an execution of the user action or the automated business process with a work step which corresponds to a user interface page on which the activity picklist is displayed.

Since a field service technician may be using a mobile device that has a relatively small user interface, the field service technician's work is more efficient if the number of the field service technician's interactions (such as “clicks”) with a work order are minimized. Therefore, the work order system can generate a work order that organizes work plans into work steps, and then display each work step as a small task next to its check box which may be marked as “completed” with just a single click or screen swipe. Since the work order system can integrate the picklist that includes at least one action and at least one lighting flow into each work step's page, a field service technician can launch an action or a flow directly from a work step's page, without having to navigate to a dedicated page for the action or the flow.

The use of a single-click activity object that triggers the display of a picklist simplifies the layout of a user interface for a field service technician. When the action or the flow is completed, the work order system can automatically update the status of the work step as completed, thereby saving the field service technician from multiple navigation steps and clicks. All functionalities of the work order system are accessible to field service technicians via application programming interface (API) calls. A mobile device application can easily call APIs to get the work done without being tightly coupled to the entire technology stack of the work order system.

For example, when Joe's repurposing of the “complete” button launches a lightning flow to order tires, the work order system automatically marks the check tire pressure work step as completed and links the prospective order of the new tires to the completed check tire pressure work step. Joe did not have enter several clicks to navigate from the launched lightning flow's page back to the check tire pressure work step page to mark the check tire pressure work step as completed. When viewing the launched lightning flow's first page, Joe enters the make, model, and year of Brian's Mercedes Benz. The launched lightning flow's second page displays the tire options available for Brian. which range from $80 to $800 per tire, but Brian does not select an option because his wife Hope is responsible for the family budget. A user of the user interface may be the user of the database system, as previous examples described only specified database system users with the capability to reconfigure the display fields output and actions of the field service technicians' user interfaces, whereas this example describes the field service technician Joe with the capability to reconfigure the actions of his own field service technician user interface.

In addition to executing an action or a flow, a selection is optionally received of another activity in an activity picklist on another user interface page associated with a work step, block 132. The system can receive selections of other activities in an activity picklist. For example, and without limitation, this can include the work order system receiving Joe's picks of other activities from the picklist, which repurpose the selection of the “complete” button to initially pause the launched lightning flow and then email a link to the paused lightning flow's page to Brian.

Having received a selection of another activity in an activity picklist, a user action, or an automated business process, which corresponds to the other activity in the activity picklist, is optionally executed, block 134. The system can enable a field service technician in the field to flexibly capture data by launching other actions or flows while viewing specific work step pages. By way of example and without limitation, this can include the work order system pausing the launched lightning flow and then emailing a link to the paused lightning flow's page to Brian. Then Brian forwards Joe's email to his wife Hope, who selects one of the paused lightning flow page's options to purchase new tires, which resumes the lightning flow, and thereby orders the new tires. A user action can be the process of a person operating a computer to achieve an aim. An automated business process can be a collection of connected tasks with little or no direct human control, which find their end in the delivery of a service or product to a customer.

After executing an action or a flow, a selection is optionally received of an activity object that is outputted on another user interface page of user interface pages associated with work steps, block 136. The system can receive a selection of the same activity object which is displayed on another work step's page. In embodiments, this can include the work order system receiving the field service technician Andrew's selection of a “complete” button displayed on the checking the windshield water work step page. While confirming that the windshield water reservoir in customer Chris' car is sufficiently filled, Andrew notices that the tire tread was low on all four tires and recommends that Chris replace the tires soon, to which Chris agrees.

Following receipt of a selection of an activity object, an activity picklist is optionally caused to be outputted on another user interface page associated with a work step, block 138. The system can display the same activity picklist on other work steps' pages. For example, and without limitation, this can include the work order system displaying the same picklist, which was previously displayed on the check tire pressure work step page, on the check windshield water work step page. Andrew selects the same activity that Joe selected from the same picklist from which Joe selected, which repurposes the selection of the “complete” button on the check windshield water work step page to launch a salesforce.com lightning flow for ordering new tires from the check windshield water work step page, which creates a database record for the prospective order. Every user can access the same picklist of activities from any work step's page, instead of requiring a system administrator to configure a single activity to be dedicated to each object that may be selected by a specific group of users from a specific work step's page.

When Andrew's repurposing of the “complete” button launches a lightning flow to order tires, the work order system automatically marks the check windshield water work step as completed, and then links the prospective order of the new tires to the completed check windshield water work step. Andrew did not have enter several clicks to navigate from the launched lightning flow's page back to the check windshield water work step page to mark the check windshield water work step as completed. When viewing the launched lightning flow's first page, Andrew enters the make, model, and year of Chris' Kia. The launched lightning flow's second page displays the tire options available for Chris, which range from $50 to $200 per tire, and Chris selects one of the lightning flow page's options to purchase new tires, which completes the lightning flow thereby ordering the new tires.

The frames 200, 210, 300, 400, 500, 600, 610, 620, 630, 640, 650, 660, 670, 700, 730, and/or 760 may be parts of larger display screens that include fields for users to enter commands to create, retrieve, edit, and store information. Because the frames 200, 210, 300, 400, 500, 600, 610, 620, 630, 640, 650, 660, 670, 700, 730, and/or 760 are samples, the frames 200, 210, 300, 400, 500, 600, 610, 620, 630, 640, 650, 660, 670, 700, 730, and/or 760 could vary greatly in appearance. For example, the relative sizes and positioning of the graphical images are not important to the practice of the present disclosure. The frames 200, 210, 300, 400, 500, 600, 610, 620, 630, 640, 650, 660, 670, 700, 730, and/or 760 may be depicted by any visual display, but they are preferably depicted by a computer screen. The frames 200, 210, 300, 400, 500, 600, 610, 620, 630, 640, 650, 660, 670, 700, 730, and/or 760 could also be output as reports and printed or saved in electronic formats, such as PDF.

The frames 200, 210, 300, 400, 500, 600, 610, 620, 630, 640, 650, 660, 670, 700, 730, and/or 760 may be parts of a personal computer system and/or a network, and operated from system data received by the network, and/or on the Internet. The 200, 210, 300, 400, 500, 600, 610, 620, 630, 640, 650, 660, 670, 700, 730, and/or 760 may be navigable by a user. Typically, a user can employ a touch screen input, voice command, or a mouse input device to point-and-click to locations on the frames 200, 210, 300, 400, 500, 600, 610, 620, 630, 640, 650, 660, 670, 700, 730, and/or 760 to manage the graphical images on the frames 200, 210, 300, 400, 500, 600, 610, 620, 630, 640, 650, 660, 670, 700, 730, and/or 760.

Alternately, a user can employ directional indicators, or other input devices such as a keyboard. The graphical images depicted by the frames 200, 210, 300, 400, 500, 600, 610, 620, 630, 640, 650, 660, 670, 700, 730, and/or 760 are examples, as the frames 200, 210, 300, 400, 500, 600, 610, 620, 630, 640, 650, 660, 670, 700, 730, and/or 760 may include much greater amounts of graphical images. The frames 200, 210, 300, 400, 500, 600, 610, 620, 630, 640, 650, 660, 670, 700, 730, and/or 760 may also include fields in which a user can input information.

The method 100 may be repeated as desired. Although this disclosure describes the blocks 102-138 executing in a particular order, the blocks 102-138 may be executed in a different order. In other implementations, each of the blocks 102-138 may also be executed in combination with other blocks and/or some blocks may be divided into a different set of blocks.

### System Overview

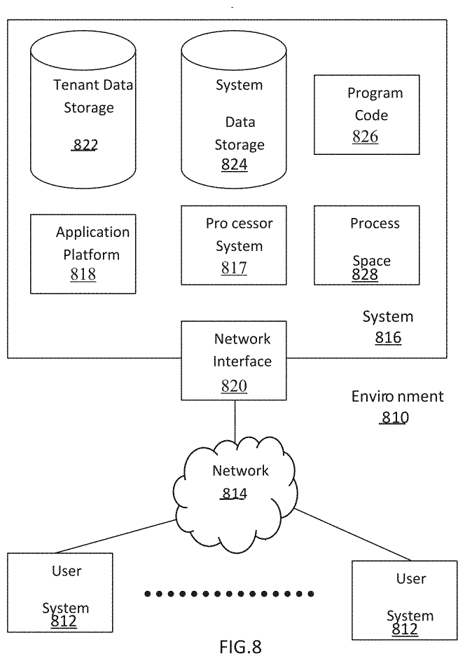

FIG. 8 illustrates a block diagram of an environment 810 wherein an on-demand database service might be used. The environment 810 may include user systems 812, a network 814, a system 816, a processor system 817, an application platform 818, a network interface 820, a tenant data storage 822, a system data storage 824, program code 826, and a process space 828. In other embodiments, the environment 810 may not have all of the components listed and/or may have other elements instead of, or in addition to, those listed above.

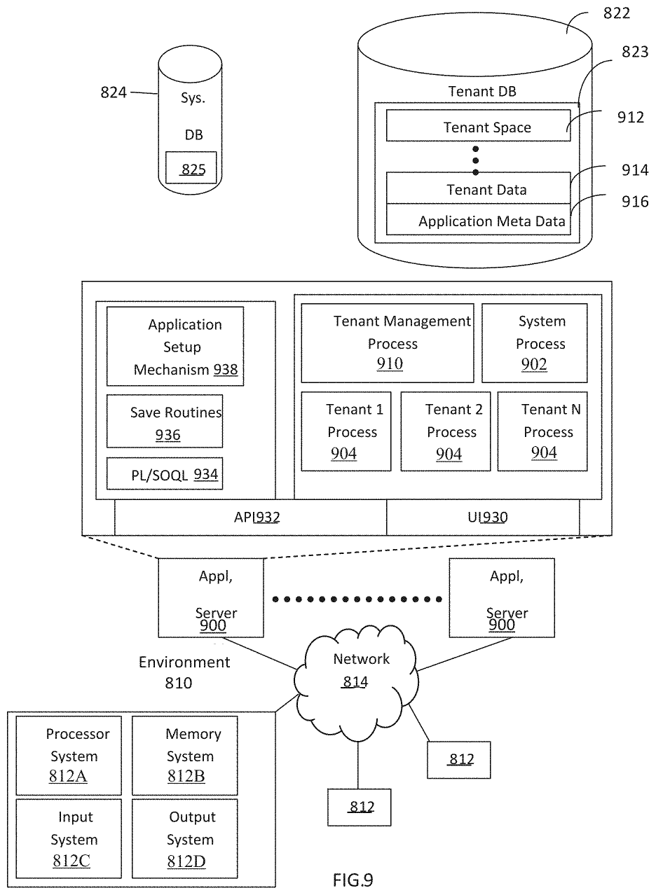

The environment 810 is an environment in which an on-demand database service exists. A user system 812 may be any machine or system that is used by a user to access a database user system. For example, any of the user systems 812 may be a handheld computing device, a mobile phone, a laptop computer, a work-station, and/or a network of computing devices. As illustrated in FIG. 8 (and in more detail in FIG. 9) the user systems 812 might interact via the network 814 with an on-demand database service, which is the system 816.

An on-demand database service, such as the system 816, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, the “on-demand database service 816” and the “system 816” will be used interchangeably herein. A database image may include one or more database objects.

A relational database management system (RDMS) or the equivalent may execute storage and retrieval of information against the database object(s). The application platform 818 may be a framework that allows the applications of the system 816 to run, such as the hardware and/or software, e.g., the operating system. In an embodiment, the on-demand database service 816 may include the application platform 818 which enables creation, managing and executing one or more applications developed by the provider of the on-demand database service, users accessing the on-demand database service via user systems 812, or third-party application developers accessing the on-demand database service via the user systems 812.

The users of the user systems 812 may differ in their respective capacities, and the capacity of a particular user system 812 might be entirely determined by permissions (permission levels) for the current user. For example, where a salesperson is using a particular user system 812 to interact with the system 816, that user system 812 has the capacities allotted to that salesperson. However, while an administrator is using that user system 812 to interact with the system 816, that user system 812 has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

The network 814 is any network or combination of networks of devices that communicate with one another. For example, the network 814 may be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

The user systems 812 might communicate with the system 816 using TCP/IP and, at a higher network level, use other common Internet protocols to communicate, such as HTTP, FTP, AFS, WAP, etc. In an example where HTTP is used, the user systems 812 might include an HTTP client commonly referred to as a “browser” for sending and receiving HTTP messages to and from an HTTP server at the system 816. Such an HTTP server might be implemented as the sole network interface between the system 816 and the network 814, but other techniques might be used as well or instead. In some implementations, the interface between the system 816 and the network 814 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, the system 816, shown in FIG. 8, implements a web-based customer relationship management (CRM) system. For example, in one embodiment, the system 816 includes application servers configured to implement and execute CRM software applications as well as provide related data, code, forms, webpages and other information to and from the user systems 812 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared.

In certain embodiments, the system 816 implements applications other than, or in addition to, a CRM application. For example, the system 816 may provide tenant access to multiple hosted (standard and custom) applications, including a CRM application. User (or third-party developer) applications, which may or may not include CRM, may be supported by the application platform 818, which manages creation, storage of the applications into one or more database objects and executing of the applications in a virtual machine in the process space of the system 816.

One arrangement for elements of the system 816 is shown in FIG. 8, including the network interface 820, the application platform 818, the tenant data storage 822 for tenant data 823, the system data storage 824 for system data 825 accessible to the system 816 and possibly multiple tenants, the program code 826 for implementing various functions of the system 816, and the process space 828 for executing MTS system processes and tenant-specific processes, such as running applications as part of an application hosting service. Additional processes that may execute on the system 816 include database indexing processes.

Several elements in the system shown in FIG. 8 include conventional, well-known elements that are explained only briefly here. For example, each of the user systems 812 could include a desktop personal computer, workstation, laptop, PDA, cell phone, or any wireless access protocol (WAP) enabled device or any other computing device capable of interfacing directly or indirectly to the Internet or other network connection. Each of the user systems 812 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of the user systems 812 to access, process and view information, pages and applications available to it from the system 816 over the network 814.

Each of the user systems 812 also typically includes one or more user interface devices, such as a keyboard, a mouse, trackball, touch pad, touch screen, pen, or the like, for interacting with a graphical user interface (GUI) provided by the browser on a display (e.g., a monitor screen, LCD display, etc.) in conjunction with pages, forms, applications, and other information provided by the system 816 or other systems or servers. For example, the user interface device may be used to access data and applications hosted by the system 816, and to perform searches on stored data, and otherwise allow a user to interact with various GUI pages that may be presented to a user. As discussed above, embodiments are suitable for use with the Internet, which refers to a specific global internetwork of networks. However, it should be understood that other networks may be used instead of the Internet, such as an intranet, an extranet, a virtual private network (VPN), a non-TCP/IP based network, any LAN or WAN or the like.

According to one embodiment, each of the user systems 812 and all of its components are operator configurable using applications, such as a browser, including computer code run using a central processing unit such as an Intel Pentium® processor or the like. Similarly, the system 816 (and additional instances of an MTS, where more than one is present) and all of their components might be operator configurable using application(s) including computer code to run using a central processing unit such as the processor system 817, which may include an Intel Pentium® processor or the like, and/or multiple processor units. A computer program product embodiment includes a machine-readable storage medium (media) having instructions stored thereon/in which may be used to program a computer to perform any of the processes of the embodiments described herein.

Computer code for operating and configuring the system 816 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), micro-drive, and magneto-optical disks, and magnetic or optical cards, nano-systems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments may be implemented in any programming language that may be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, the system 816 is configured to provide webpages, forms, applications, data, and media content to the user (client) systems 812 to support the access by the user systems 812 as tenants of the system 816. As such, the system 816 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B).

As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein may be implemented as single databases, a distributed database, a collection of distributed databases, a database with redundant online or offline backups or other redundancies, etc., and might include a distributed database or storage network and associated processing intelligence.

FIG. 9 also illustrates the environment 810. However, in FIG. 9 elements of the system 816 and various interconnections in an embodiment are further illustrated. FIG. 9 shows that the each of the user systems 812 may include a processor system 812A, a memory system 812B, an input system 812C, and an output system 812D.

FIG. 9 shows the network 814 and the system 816. FIG. 9 also shows that the system 816 may include the tenant data storage 822, the tenant data 823, the system data storage 824, the system data 825, a User Interface (UI) 930, an Application Program Interface (API) 932, a PL/SOQL 934, save routines 936, an application setup mechanism 938, applications servers 900₁-900_{N}, a system process space 902, tenant process spaces 904, a tenant management process space 910, a tenant storage area 912, a user storage 914, and application metadata 916. In other embodiments, the environment 810 may not have the same elements as those listed above and/or may have other elements instead of, or in addition to, those listed above.

The user systems 812, the network 814, the system 816, the tenant data storage 822, and the system data storage 824 were discussed above in FIG. 8. Regarding the user systems 812, the processor system 812A may be any combination of one or more processors. The memory system 812B may be any combination of one or more memory devices, short-term, and/or long-term memory.

The input system 812C may be any combination of input devices, such as one or more keyboards, mice, trackballs, scanners, cameras, and/or interfaces to networks. The output system 812D may be any combination of output devices, such as one or more monitors, printers, and/or interfaces to networks. As shown by FIG. 9, the system 816 may include the network interface 820 (of FIG. 8) implemented as a set of HTTP application servers 900, the application platform 818, the tenant data storage 822, and the system data storage 824.

Also shown is the system process space 902, including individual tenant process spaces 904 and the tenant management process space 910. Each application server 900 may be configured to access tenant data storage 822 and the tenant data 823 therein, and the system data storage 824 and the system data 825 therein to serve requests of the user systems 812. The tenant data 823 might be divided into individual tenant storage areas 912, which may be either a physical arrangement and/or a logical arrangement of data. Within each tenant storage area 912, the user storage 914 and the application metadata 916 might be similarly allocated for each user.

For example, a copy of a user's most recently used (MRU) items might be stored to the user storage 914. Similarly, a copy of MRU items for an entire organization that is a tenant might be stored to the tenant storage area 912. The UI 930 provides a user interface, and the API 932 provides an application programmer interface to the system 816 resident processes to users and/or developers at the user systems 812. The tenant data and the system data may be stored in various databases, such as one or more Oracle™ databases.

The application platform 818 includes the application setup mechanism 938 that supports application developers' creation and management of applications, which may be saved as metadata into the tenant data storage 822 by the save routines 936 for execution by subscribers as one or more tenant process spaces 904 managed by the tenant management process 910 for example. Invocations to such applications may be coded using the PL/SOQL 934 that provides a programming language style interface extension to the API 932. A detailed description of some PL/SOQL language embodiments is discussed in commonly owned U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is incorporated in its entirety herein for all purposes. Invocations to applications may be detected by one or more system processes, which manages retrieving the application metadata 916 for the subscriber making the invocation and executing the metadata as an application in a virtual machine.

Each application server 900 may be communicably coupled to database systems, e.g., having access to the system data 825 and the tenant data 823, via a different network connection. For example, one application server 900₁ might be coupled via the network 814 (e.g., the Internet), another application server 900_{N-1} might be coupled via a direct network link, and another application server 900_{N} might be coupled by yet a different network connection. Transfer Control Protocol and Internet Protocol (TCP/IP) are typical protocols for communicating between application servers 900 and the database system. However, it will be apparent to one skilled in the art that other transport protocols may be used to optimize the system depending on the network interconnect used.

In certain embodiments, each application server 900 is configured to handle requests for any user associated with any organization that is a tenant. Because it is desirable to be able to add and remove application servers from the server pool at any time for any reason, there is preferably no server affinity for a user and/or organization to a specific application server 900. In one embodiment, therefore, an interface system implementing a load balancing function (e.g., an F5 Big-IP load balancer) is communicably coupled between the application servers 900 and the user systems 812 to distribute requests to the application servers 900.

In one embodiment, the load balancer uses a least connections algorithm to route user requests to the application servers 900. Other examples of load balancing algorithms, such as round robin and observed response time, also may be used. For example, in certain embodiments, three consecutive requests from the same user could hit three different application servers 900, and three requests from different users could hit the same application server 900. In this manner, the system 816 is multi-tenant, wherein the system 816 handles storage of, and access to, different objects, data and applications across disparate users and organizations.

As an example of storage, one tenant might be a company that employs a sales force where each salesperson uses the system 816 to manage their sales process. Thus, a user might maintain contact data, leads data, customer follow-up data, performance data, goals, and progress data, etc., all applicable to that user's personal sales process (e.g., in the tenant data storage 822). In an example of a MTS arrangement, since all of the data and the applications to access, view, modify, report, transmit, calculate, etc., may be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by the system 816 that are allocated at the tenant level while other data structures might be managed at the user level. Because an MTS might support multiple tenants including possible competitors, the MTS should have security protocols that keep data, applications, and application use separate.

Also, because many tenants may opt for access to an MTS rather than maintain their own system, redundancy, up-time, and backup are additional functions that may be implemented in the MTS. In addition to user-specific data and tenant specific data, the system 816 might also maintain system level data usable by multiple tenants or other data. Such system level data might include industry reports, news, postings, and the like that are sharable among tenants.

In certain embodiments, the user systems 812 (which may be client systems) communicate with the application servers 900 to request and update system-level and tenant-level data from the system 816 that may require sending one or more queries to the tenant data storage 822 and/or the system data storage 824. The system 816 (e.g., an application server 900 in the system 816) automatically generates one or more SQL statements (e.g., one or more SQL queries) that are designed to access the desired information. The system data storage 824 may generate query plans to access the requested data from the database.

Each database can generally be viewed as a collection of objects, such as a set of logical tables, containing data fitted into predefined categories. A “table” is one representation of a data object, and it may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields.

For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, filed Apr. 2, 2004, entitled “Custom Entities and Fields in a Multi-Tenant Database System”, which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A system for a user interface to dynamically update the display of display fields for work steps and work plans for work orders, the system comprising:
one or more processors; and
a non-transitory computer readable medium storing a plurality of instructions, which when executed, cause the one or more processors to:
receive a request, by a database system, from a user interface to output a work order;
identify, by the database system, a work plan for the work order, in response to receiving the request from the user interface to output the work order;
cause, by the database system, the user interface to output display fields for the work order and the work plan;
receive a request, by the database system, from a user of the database system to add at least one of an additional work plan and an additional work step; and
cause, by the database system, the user interface to dynamically update the output of the display fields for the work order and/or the work plan by adding an additional output of at least one display field corresponding to the at least one of the additional work plan and the additional work step, in response to the database system receiving the request from the user of the database system.

2. The system of claim 1, wherein each output display field is selected by the user from all configurable display fields for the work order and the work plan, thereby configuring each output display field to be output and to be dynamically updated for the work order and work plan.

3. The system of claim 1, comprising further instructions, which when executed, cause the one or more processors to cause the database system to dynamically update database records associated with the display fields for the work order, the work plan, and any work steps, in response to receiving an input, from the user interface, which is associated with at least one of the display fields for the work order, the work plan, and any work steps.

4. The system of claim 1, wherein at least one of the additional work plan comprises a custom work plan created by the user and the additional work step comprises a custom work step created by the user.

5. The system of claim 1, wherein a user of the user interface comprises the user of the database system.

6. The system of claim 1, comprising further instructions, which when executed, cause the one or more processors to cause, by the database system, the user interface to dynamically update the output of the display fields for the work order and the work plan by deleting any output of at least one display field corresponding to at least one of a selected work plan and a selected work step, in response to the database system receiving a request from the user to delete the at least one of the selected work plan and the selected work step.

7. The system of claim 1, comprising further instructions, which when executed, cause the one or more processors to cause, by the database system, the user interface to dynamically update the output of the display fields for the work order and the work plan by modifying any output of at least one display field corresponding to at least one of a chosen work plan and a chosen work step, in response to the database system receiving a request from the user to modify at least one of the chosen work plan and the chosen work step.

8. A computer program product comprising computer-readable program code to be executed by one or more processors when retrieved from a non-transitory computer-readable medium, the program code including instructions to:
receive a request, by a database system. from a user interface to output a work order;
identify, by the database system, a work plan for the work order, in response to receiving the request from the user interface to output the work order;
cause, by the database system, the user interface to output display fields for the work order and the work plan;
receive a request, by the database system, from a user of the database system to add at least one of an additional work plan and an additional work step; and
cause, by the database system, the user interface to dynamically update the output of the display fields for the work order and/or the work plan by adding an additional output of at least one display field corresponding to the at least one of the additional work plan and the additional work step, in response to the database system receiving the request from the user of the database system.

9. The computer program product of claim 8, wherein each output display field is selected by the user from all configurable display fields for the work order and the work plan, thereby configuring each output display field to be output and to be dynamically updated for the work order and work plan.

10. The computer program product of claim 8, wherein the program code comprises further instructions to cause the database system to dynamically update database records associated with the display fields for the work order, the work plan, and any work steps, in response to receiving an input, from the user interface, which is associated with at least one of the display fields for the work order, the work plan, and any work steps.

11. The computer program product of claim 8, wherein at least one of the additional work plan comprises a custom work plan created by the user and the additional work step comprises a custom work step created by the user.

12. The computer program product of claim 8, wherein a user of the user interface comprises the user of the database system.

13. The computer program product of claim 8, wherein the program code comprises further instructions to cause, by the database system, the user interface to dynamically update the output of the display fields for the work order and the work plan by deleting any output of at least one display field corresponding to at least one of a selected work plan and a selected work step, in response to the database system receiving a request from the user to delete the at least one of the selected work plan and the selected work step.

14. The computer program product of claim 8, wherein the program code comprises further instructions to cause, by the database system, the user interface to dynamically update the output of the display fields for the work order and the work plan by modifying any output of at least one display field corresponding to at least one of a chosen work plan and a chosen work step, in response to the database system receiving a request from the user to modify at least one of the chosen work plan and the chosen work step.

15. A computer-implemented method for a user interface to dynamically update the display of work steps and/or work plans for work orders, the computer-implemented method comprising:
receiving a request, by a database system, from a user interface to output a work order;
identifying, by the database system, a work plan for the work order, in response to receiving the request from the user interface to output the work order;
causing, by the database system, the user interface to output display fields for the work order and the work plan;
receiving a request, by the database system, from a user of the database system to add at least one of an additional work plan and an additional work step;
causing, by the database system, the user interface to dynamically update the output of the display fields for the work order and/or the work plan by adding an additional output of at least one display field corresponding to the at least one of the additional work plan and the additional work step, in response to the database system receiving the request from the user of the database system.

16. The computer-implemented method of claim 15, wherein each output display field is selected by the user from all configurable display fields for the work order and the work plan, thereby configuring each output display field to be output and to be dynamically updated for the work order and work plan.

17. The computer-implemented method of claim 15, the computer-implemented method further comprising causing the database system to dynamically update database records associated with the display fields for the work order, the work plan, and any work steps, in response to receiving an input, from the user interface, which is associated with at least one of the display fields for the work order, the work plan, and any work steps.

18. The computer-implemented method of claim 15, wherein at least one of the additional work plan comprises a custom work plan created by the user and the additional work step comprises a custom work step created by the user. wherein a user of the user interface comprises the user of the database system.

19. The computer-implemented method of claim 15, the computer-implemented method further comprising causing, by the database system, the user interface to dynamically update the output of the display fields for the work order and the work plan by deleting any output of at least one display field corresponding to at least one of a selected work plan and a selected work step, in response to the database system receiving a request from the user to delete the at least one of the selected work plan and the selected work step.

20. The computer-implemented method of claim 15, the computer-implemented method further comprising causing, by the database system, the user interface to dynamically update the output of the display fields for the work order and the work plan by modifying any output of at least one display field corresponding to at least one of a chosen work plan and a chosen work step, in response to the database system receiving a request from the user to modify at least one of the chosen work plan and the chosen work step.
